(19) United States
(12) Patent Application Publication
(10) Pub. No.: US 2004/0041711 A1
(43) Pub. Date: Mar. 4, 2004

(54) Optical communication disk with built-in computing unit and methods processing information therewith

(76) Inventor: Amos Loewidt, Rosh Haayin (IL)

Correspondence Address: Mark Friedman, Bill Polkinghorn, Discovery Dispatch, 9003 Florin Way, Upper Marlboro, MD, 20772, US

(21) Appl. No.: 10/451,386

(22) PCT Filed: Dec. 26, 2001
(86) PCT No.: PCT/IL01/01201

(30) Foreign Application Priority Data
Dec. 26, 2000 (IL) 140557

(51) Int. Cl. H04Q 1/00

(52) U.S. Cl. 340/825.52

(57) ABSTRACT

An optical communication device and method, the device including: (a) a data card having (i) a computing unit, and (ii) an optical communication element operatively connected to the computing unit, the optical communication element for transferring optical information between the computing unit and an external device.

### FIELD AND BACKGROUND OF THE INVENTION

The present invention relates to an optical communication card having a built-in computing unit, to a method of processing information therewith, and to a method of communicating between the card user and an external optical card-reading unit such as a CD-ROM drive.

U.S. Pat. No. 5,932,866 incorporates an optical card and an ISO standard chip with external contacts. A compact disc recording device reads and writes data onto the optical regions of the card, and in addition, the onboard chip is used to manage optical data access. This invention suffers from a limitation due to being dependent on the IC chip terminal contacts to communicate with an external device.

U.S. Pat. No. 5,777,903 includes a card with an onboard solar cell, keypad, display and a data interface terminal. This enables the card user to access data stored on the card without resorting to the use of external devices. However, this type of card has a low memory capacity, and requires frequent insertion into a network or personal computing device in order to synchronize and update financial information stored thereon.

U.S. Pat. No. 5,932,865 addresses counterfeiting of electronic cash cards by attaching a optical stripe containing security verification data on the body of a cash card, where this security verification data could be read by an external device and compared to interrogated identification data. This method does not provide for storage of several user identities, storage of accounts with several institutions, and provides only a one-level, one-step security procedure.

It must be emphasized that transactions involving user investment, credit and money transfers require reliable and verifiable data transferred between the card user and recipient.

There is therefore a recognized need for an improved smart card that would incorporate a data storage area, communicating methods with private computing devices, and an independent and reliable power supply. Moreover, it would be highly advantageous to have a method for the storage and exchange of private financial and personal information significantly more secure than methods known heretofore. It would be of further advantage to enable the incorporation of data from more than one source and to allow interaction with more than one type of computing device. It would also be of further advantage for such a card to be functional from a regular CD Drive.

### SUMMARY OF THE INVENTION

According to one aspect of the present invention there is provided an optical communication device including: (a) a data card having: (i) a computing unit, and (ii) an optical communication element operatively connected to the computing unit, the optical communication element for transferring optical information between the data card and an external device.

According to another aspect of the present invention there is provided a method for communicating information including the steps of: (a) providing a device including a data disc having: (i) a computing unit, and (ii) an optical communication element, operatively connected to the computing unit; (b) communicating optical information between the data disc and an external device using the optical communication element.

According to one feature of the present invention, described in the preferred embodiments, the physical dimensions of the card resemble a credit card.

According to another feature of the present invention, described in the preferred embodiments, the first side of the card includes an optical data area.

According to yet another feature of the present invention, described in the preferred embodiments, the second side obverse to the first side includes an electrical contact area.

According to yet another feature of the present invention, described in the preferred embodiments, at least one of the sides of the card includes at least one electric current generation area.

According to yet another feature of the present invention, described in the preferred embodiments, the sides include a magnetic contact area.

According to yet another feature of the present invention, described in the preferred embodiments, the card further includes: (iii) an energy storage cell for providing energy to the computing unit.

According to yet another feature of the present invention, described in the preferred embodiments, the storage cell includes an electric battery.

According to yet another feature of the present invention, described in the preferred embodiments, the electric current generation area includes at least one type of cell selected from the group consisting of photoelectric cell, photovoltaic cell, and solar cell.

According to yet another feature of the present invention, described in the preferred embodiments, the computing unit is operatively connected to the cell.

According to yet another feature of the present invention, described in the preferred embodiments, the battery is disposed so as to provide substantially even radial weight distribution of the card.

According to yet another feature of the present invention, described in the preferred embodiments, the card is substantially circular.

According to yet another feature of the present invention, described in the preferred embodiments, data card further includes: (iii) a sector-shaped optical data area, the sector-shaped area extending less than 360°.

According to yet another feature of the present invention, described in the preferred embodiments, the card is a compact disc.

According to yet another feature of the present invention, described in the preferred embodiments, the external device is a compact disc (CD) drive.

According to yet another feature of the present invention, described in the preferred embodiments, the external device is a compact disc (CD) drive reader.

According to yet another feature of the present invention, described in the preferred embodiments, the card is a compact disc, and further includes: (iii) an optically recordable data region for recording data from a laser.

According to yet another feature of the present invention, described in the preferred embodiments, the optical communication element includes at least one light absorption device and at least one light emission device.

According to yet another feature of the present invention, described in the preferred embodiments, the light absorption device includes photosensitive cells.

According to yet another feature of the present invention, described in the preferred embodiments, the light emitting device includes at least one device selected from the group consisting of light emitting diode (LED), multichip micropod, LED light strip, laser diode (LD), and flexible path LED.

According to yet another feature of the present invention, described in the preferred embodiments, the computing unit includes at least one integrated circuit chip selected from the group consisting of ceramic, reflector, flat, lens, dual color, dual color reflector, resistor and blinking chip.

According to yet another feature of the present invention, described in the preferred embodiments, the computing unit includes a random access memory region.

According to yet another feature of the present invention, described in the preferred embodiments, the computing unit further includes a memory region selected from the group consisting of a read only memory region, and an electrically programmable memory region.

According to yet another feature of the present invention, described in the preferred embodiments, the memory regions contain data and programs.

According to yet another feature of the present invention, described in the preferred embodiments, the programs include a memory access program.

According to yet another feature of the present invention, described in the preferred embodiments, the programs include an operation system.

According to yet another feature of the present invention, described in the preferred embodiments, the programs include an identification program.

According to yet another feature of the present invention, described in the preferred embodiments, the programs include a data processing program.

According to yet another feature of the present invention, described in the preferred embodiments, the CD drive reader is designed and configured to transmit optical data using an on/off method.

According to yet another feature of the present invention, described in the preferred embodiments, the CD drive reader is designed and configured to transmit optical data using a focus manipulating method.

According to yet another feature of the present invention, described in the preferred embodiments, the CD drive is designed and configured to transmit optical data using a modulated beam over an on/off pin.

According to yet another feature of the present invention, described in the preferred embodiments, the optical communication element includes a light emitting diode (LED).

According to yet another feature of the present invention, described in the preferred embodiments, the optical communication element includes a laser diode (LD).

According to yet another feature of the present invention, described in the preferred embodiments, the card further includes: (iii) a photo-detection element operatively connected to the computing unit.

According to yet another feature of the present invention, described in the preferred embodiments, the communicating of optical information includes receiving an optical input from an external light source using the optical communication element.

According to yet another feature of the present invention, described in the preferred embodiments, the communicating of optical information includes transmitting an optical output to an external device using the optical communication element.

According to yet another feature of the present invention, described in the preferred embodiments, the optical communication element is a diode selected from the group consisting of a light emitting diode (LED) and a laser diode (LD).

According to yet another feature of the present invention described in the preferred embodiments, the computing unit processes digital information.

According to yet another feature of the present invention, described in the preferred embodiments, the digital information includes programs for operation of the device.

According to yet another feature of the present invention, described in the preferred embodiments, the computing unit processes at least one type of data selected from the group consisting of permanent, temporary and write-once data.

According to yet another feature of the present invention, described in the preferred embodiments, the computing unit processes data containing information selected from the group consisting of financial, security, identification and personal information.

According to yet another feature of the present invention, described in the preferred embodiments, the external light source is operatively connected to a CD-drive.

According to yet another feature of the present invention, described in the preferred embodiments, the receiving of an optical input is performed using an on/off method.

According to yet another feature of the present invention, described in the preferred embodiments, the receiving of an optical input is performed using a focus manipulating method.

According to yet another feature of the present invention, described in the preferred embodiments, the receiving of an optical input is performed using a modulated beam.

According to yet another feature of the present invention, described in the preferred embodiments, the receiving of an optical input is performed using an OS discovering process.

According to yet another feature of the present invention, described in the preferred embodiments, the receiving of an optical input is performed using a Reload Track command.

According to yet another feature of the present invention, described in the preferred embodiments, the receiving of an optical input is performed using a SEEK command.

According to yet another feature of the present invention, described in the preferred embodiments, the receiving of an optical input is performed by controlling a position of a lens of the external light source such that the lens moves in and out from beneath a detecting area.

According to yet another feature of the present invention, described in the preferred embodiments, the computing unit communicates with an optical data storage area disposed on the disc.

According to yet another feature of the present inventions described in the preferred embodiments, the optical data storage area includes recordable, readable, permanent, read-only, and write-once only areas.

According to yet another feature of the present invention, described in the preferred embodiments, the computing unit processes operation system commands.

According to yet another feature of the present invention, described in the preferred embodiments, the computing unit controls communication of the disc with an external device by means of the optical communication element.

According to yet another feature of the present invention, described in the preferred embodiments, the data disposed in the computing unit is received from and communicated to an optical storage area by means of the light source.

According to yet another feature of the present invention, described in the preferred embodiments, the method further includes the step of: (c) encrypting data on the disc.

According to yet another feature of the present invention, described in the preferred embodiments, the method further includes the step of: (c) encrypting data, wherein the data is encrypted by at least one algorithm disposed on the disc.

According to yet another feature of the present invention, described in the preferred embodiments, the method further includes the step of: (c) encrypting data, wherein the encrypting data is performed using a canned encryption routine.

According to another aspect of the present invention there is provided a device including a data disc having at least one element for generating current from a laser of compact disc (CD) drive.

According to yet another feature of the present invention, described in the preferred embodiments, the disc includes a computing unit operatively connected to the element.

According to yet another feature of the present invention, described in the preferred embodiments, the element includes at least one cell selected from the group consisting of photoelectric and photovoltaic cells.

According to yet another feature of the present invention, described in the preferred embodiments, the device further includes solar cells for additional generation of electrical current.

According to yet another feature of the present invention, described in the preferred embodiments, the device further includes a battery for storing the current and for providing additional current as needed.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1a is a schematic diagram representing side A of the combination card of the present invention;

FIG. 1b is a schematic diagram representing side B of the combination card of the present invention;

FIG. 2a is a schematic diagram representing a sectional view of the inventive card along line AA-AA;

FIG. 2b is a schematic diagram representing a sectional view of the inventive card along line BB-BB;

FIG. 2c is a schematic diagram representing a sectional view of the inventive card along line CC-CC;

FIG. 3a is a block diagram illustrating an energy management aspect of one embodiment of the present invention;

FIG. 3b is a block diagram illustrating a data management aspect of one embodiment of the present invention;

FIG. 4 is a schematic diagram of a CD-like optical card of the present invention;

FIG. 5 is a schematic diagram of a CD-like optical card of the present invention, in which the on-board battery is annular and concentric with the central opening of the card;

FIG. 6 is a graph showing the pulsation of light, versus time, using the “Reload Track” command;

FIG. 7a shows an exemplary sequence of command for a binary signal of “00001111”, using the “On/Off” method for transferring information from the CD-Drive to the medium;

FIG. 7b shows an exemplary sequence of command for a binary signal of “00001111”, using the “Focus Manipulating” method for transferring information from the CD-Drive to the medium;

FIG. 8a is a schematic diagram of an optical medium having a semi-transparent foil, for passing a portion of a transmitted laser beam, and

FIG. 8b is a schematic diagram of the optical medium of FIG. 8a, through which information is optically transferred back to the CD-Drive.

### DESCRIPTION OF PREFERRED EMBODIMENTS

One aspect of the present invention utilizes a combination of a card-shaped compact disc (CD) or Digital Video Disc (DVD), and an integrated circuit (IC) chip. The combination card further contains an optical area that can be written on or read from by a compact disc reading and writing device further employing a beam of light and laser including one or more light frequency.

In a preferred embodiment, the combination card in the invention also contains a magnetic strip, which enables the card to function as a magnetic swipe card, thereby allowing for conventional use in devices that accept these cards. The magnetic strip is connected to the IC chip, such that the magnetic strip can serve as an input/output port of the combination card. Thus, the IC chip integrally controls the function of the magnetic strip on the card.

The principles and operation of the device and method according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

As used herein in the specification and in the claim section that follows, the terms “compact disc”, “CD” and the like refer to optical media including CD-ROM, CD-R, Double CD, Double CD Writers, GD-ROM, GD-R, DVD-ROM, DVD-R/RW, DVD-RAM, and similar optical media.

As used herein in the specification and in the claim section that follows, the terms “compact disc drive”, “CD-drive”, and the like include CD-ROM drives, CD-R drives, Double CD drives, Double CD Writers, GD-ROM drives, GD-R drives, DVD-ROM drives, DVD-R/RW drives, DVD-RAM drives, and similar optical drives.

As used herein in the specification and in the claim section that follows, the terms “compact disc drive reader”, “CD-drive reader”, and the like refer to optical drives having the capability of reading a CD, but do not have the capability of writing to a CD (according to prior-art technologies), and include CD-ROM drives, Double CD drives, GD-ROM drives, DVD-ROM drives, and similar optical drives.

As used herein in the specification and in the claim section that follows, the term “computing unit” refers to an integrated circuit device commonly referred to as a chip, which performs computing functions.

As used herein in the specification and in the claim section that follows, the term “optical data area” refers to an area having optically recordable data storage tracks, optically sensitive cells capable of producing an electrical signal corresponding to the ON bit of binary data upon exposure to a coherent light beam, and producing an electrical signal, or, conversely, an absence of a signal corresponding to the OFF bit of binary data upon a corresponding light input from the light beam.

As used herein in the specification and in the claim section that follows, the term “external device” includes various devices including a standalone type of disc drive, a CD drive, a DVD drive, a magnetic card reading slot, a module equipped with electrical contacts, and any computing device that incorporates any of the above.

As used herein in the specification and in the claim section that follows, the term “electrical contact” refers to a completion of electrical or electronic circuits of different devices by means of contact between matching surfaces located on each of the devices.

As used herein in the specification and in the claim section that follows, the term “magnetic contact” refers to a state of proximity of a source of an electromagnetic field and its modulated forms to an object capable of receiving the modulated forms or capable of inducing corresponding electromagnetic energy due to the proximity to such an object.

As used herein in the specification and in the claim section that follows, the term “photosensitive” refers to any device producing measurable change in its electric or physical feature upon being exposed to light.

As used herein in the specification and in the claim section that follows, the term “multichip micropod” refers to a microscopic cluster of specially arranged chips.

As used herein in the specification and in the claim section that follows, the term “personal information” refers to private information of an individual or to private activities of the individual. Such information is typically authored by an individual, his family members, his employers, membership institutions, financial institutions, and/or governmental institutions.

As used herein in the specification and in the claim section that follows, the term “secure” refers to a state of information being protected from any unauthorized entity during and after information exchange between two parties.

As used herein in the specification and in the claim section that follows, the term “encryption” refers to a process whereby numbers and letters including information are represented by a series of characters, wherein representing characters may not be constant and may change according to a defined algorithm.

As used herein in the specification and in the claim section that follows, the term “identifier” refers to a set of characters that are unique representation of an entity, information or a set of characters.

As used herein in the specification and in the claim section that follows, the term “algorithrn” refers to a sequence of operations or a set of formulas, whereby character sequence of data is coded, ciphered, encrypted, or transformed into a different format or character sequence.

As used herein in the specification and in the claim section that follows, the term “party” refers to an individual, a corporate entity that is a card-issuing authority, an authentication authority, a financial institution, or a computing device of any of the above.

As used herein in the specification and in the claim section that follows, the term “encryption key” refers to a discrete sequence of algorithms or characters corresponding to a block of information, that may be defined as specific to the time, size, location and sequence of information being written or accessed, so as to serve as a unique validation tool in accessing the information by the parties exchanging the information and such keys thereto.

As used herein in the specification and in the claim section that follows, the term “ciphering” refers to algebraic coding of characters based on representing sensitive information in numerical form and calculating the individual numbers thereof with predetermined mathematical formulas.

As used herein in the specification and in the claim section that follows, the term “coding” refers to a process of substituting individual character of sensitive information with at least one discrete predetermined character.

As used herein in the specification and in the claim section that follows, the term “identification” refers to a process wherein a set of characters unique to an identity of an individual is ascertained as belonging to the individual of such identity.

As used herein in the specification and in the claim section that follows, the term “validation” refers to a process wherein information that includes the identity of the individual associated with the data is checked to be valid with respect to at least one of the following: origin, authorship, authenticity certification and other parameters.

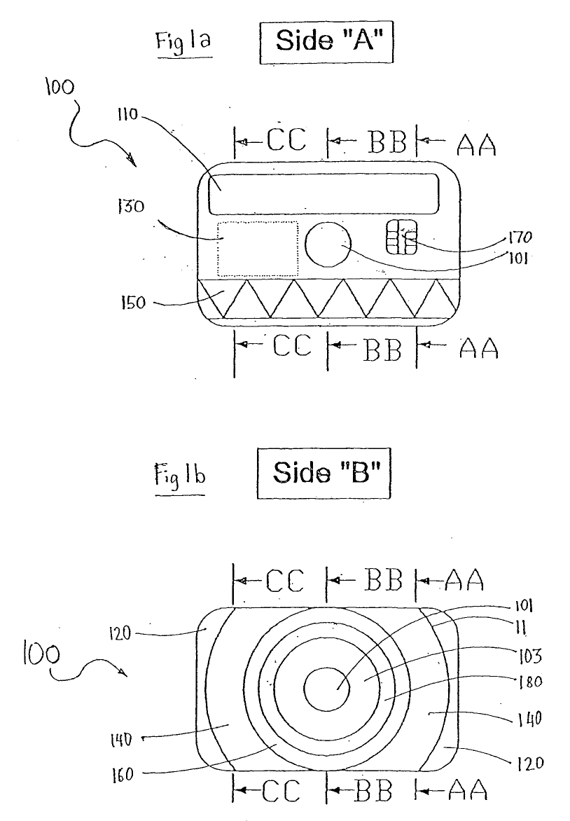

Referring now to the drawings, FIG. 1a is a schematic diagram of side A of a combination card 100 of the present invention. Card 100 is preferably made from synthetic materials by any of the methods commonly used in the art for manufacturing credit cards and the like. Card 100 is typically up to 90 mm long and up to 64 mm wide, and is preferably about 86 mm long and about 54 mm wide. In the center of card 100 there is disposed a circular hollow opening 101 whose diameter is identical to the 15 mm diameter of the inner opening of a standard compact disc.

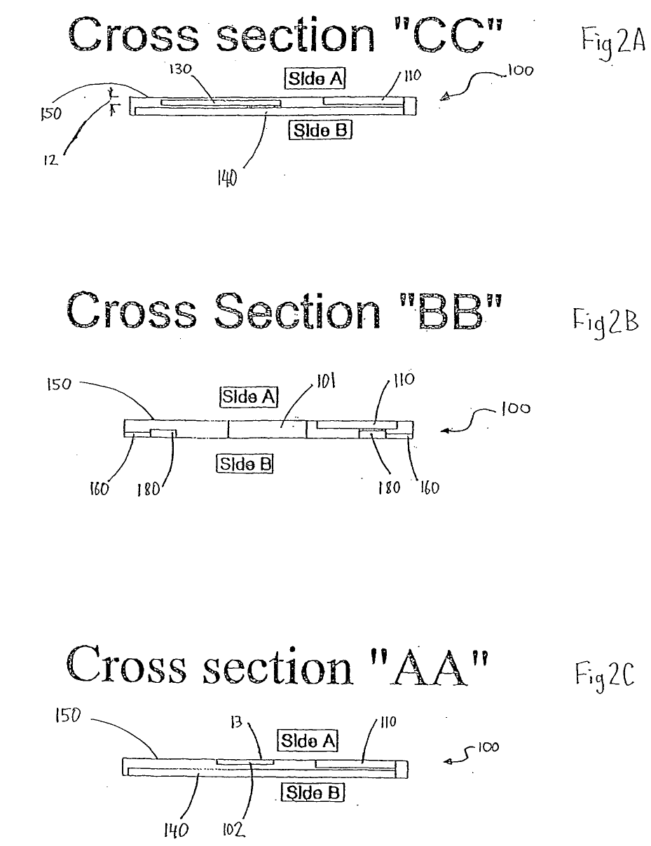

ISO 7816-2 standard terminal 170 includes within it a group of data contacts and power contacts. Terminal 170 is a contiguous surface part of IC chip 102, which is disposed in card 100 and is better illustrated by a sectional view along line AA (FIG. 2c). Also disposed within card 100 is electrical storage cell 130. Superior to opening 101 is disposed an ambient light photoelectric current generating cell area 110. Below opening 101 is disposed a magnetic contact area 150. Magnetic contact area 150 is a strip, typically 50-200 microns thick and 10-40 mm wide and common to magnetic strips in known magnetic swipe cards.

Card owner name and financial institution identity can be imprinted by any methods known in the art on any of the surface areas wherein storage cell 130 is disposed thereunder, the free area between the ISO 7816-2 standard terminal 170, and areas excluding opening 101 and magnetic contact area 150.

FIG. 1b represents side B of the inventive combination card 100. On the face of side B, there is an elevated area, externally bounded by a circumferential curve 11. The elevated area preferably has a height of at least 0.5 mm and a diameter of about 81 mm to allow proper placement of card 100 onto the drawer of a standard commercial compact disc drive and for structural accommodation of the optical data areas. Concentrically and outwardly disposed with respect to opening 101 is annular area 103, and successively, laser power absorption area 180, annular area 160, and optical data area 140. Area 120, which is disposed concentrically and externally to of optical data area 140, is bound externally by the perimeter of card 100.

Laser power absorption area 180 includes photoelectric cells that convert the light energy of the external laser data beam into electric current that is subsequently stored in electric storage cell 130. Annular area 160 includes laser-recordable and laser-readable RAM and ROM optical data tracks common to compact discs available commercially. At present, approximately 73-82 megabytes of data can be stored in the combination card laser-recordable and laser-readable ROM and RAM areas.

Optical data area 140 includes cells that accomplish IC chip data optical input and output. Input to a chip disposed under and integral to contacts 170 is accomplished by photoelectric cells that upon exposure to a coherent beam of an external device laser produce electrical impulses, or bursts of current that represent signals that include the binary information relayed by the laser beam. The chip output is produced by electric current modulated by the chip to generate coherent binary signals that consequently cause the light emitting cells in optical data area 140 to emit corresponding optical binary information. The light emitting cells of optical data area 140 can be selected from a plurality of types, including Light Emitting Diode (LED), multichip micropods, LED light strip and flexible path LED. These preferably include one or more chips, including chips that further include ceramic, reflector, flat, lens, dual color, dual color reflector, resistor and blinking chips.

Preferably, optical data area 140 has an outer diameter 11 of about 81 mm. Optical data area 140 can be a sector-shaped, as shown, such that the surface area of card 100 is more filly utilized.

Area 120 contains a plurality of photoelectric current generating cells. Concurrently with the photoelectric current generating cells in area 110 of side A, photoelectric current generating cells in area 120 produce electric current from any ambient light striking the cells, including sunlight, light produced by incandescent and fluorescent lighting of public and residential structures, etc.

Annular area 103 is preferably reserved as additional capacity for laser power absorption area 180 or for area 120.

FIG. 2a provides a schematic illustration of a section view of combination card 100 along line CC. Electric storage cell 130 is located internally within card 100 and within half layer 12 of side A of card 100. Ambient light photoelectric current generating cells (ALPGC) 110 are disposed facing side A. Optical data area 140 faces side B of card 100.

FIG. 2b provides a schematic illustration of a section view of combination card 100 along line BB. Hollow circular opening 101 is located centrally within card 100. Ambient light photoelectric current generating cells (ALPGC) 110 and magnetic contact area 150 form an integral part of card 100 and face side A of the card. Sections of laser light photoelectric current generating cells (LLPGC) in area 180 and annular area 160 are disposed symmetrically to opening 101 and face side B of card 100.

FIG. 2c provides a schematic illustration of a section view of combination card 100 along line AA. Magnetic contact area 159, IC chip 102 having terminal 170 on the surface, and (ALPGC) 110 face side A of card 100. Optical data area 140 faces side B.

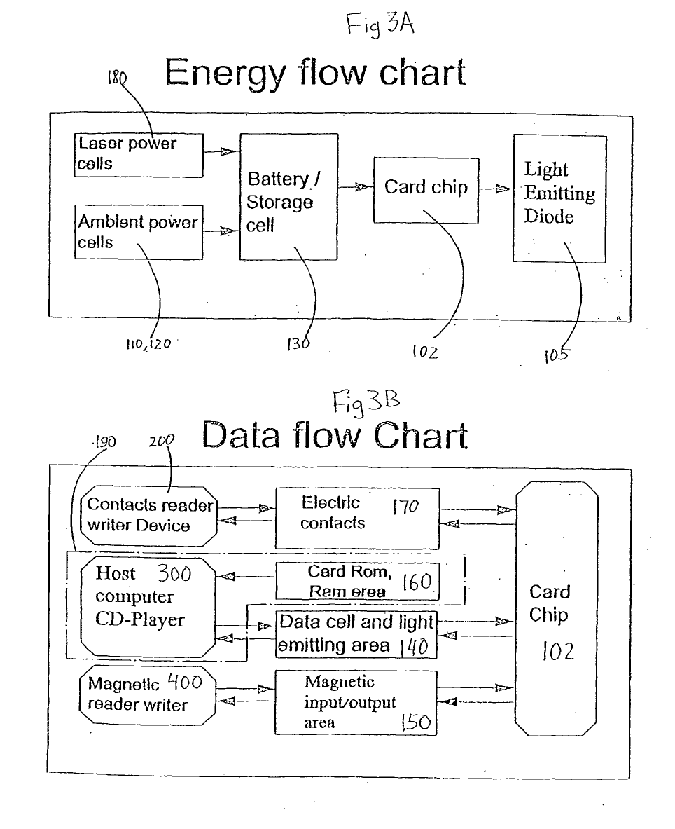

The electric power management of the combination card in the invention can be better understood by referring to the block diagram provided in FIG. 3a, which illustrates an energy management aspect of one embodiment of the present invention. Electric current produced by laser light photoelectric current generating cells (LLPGC) in area 180 and/or ambient light photoelectric current generating cells (ALPGC) in area 110 of side A and in area 120 of side B continuously charge electric storage cell 130. Storage cell 130 provides IC chip 102 with a continuous power supply, which is required for IC chip 102 to produce an optical data signal output from one of light emitting diodes 105 disposed in a data input and output area of optical data area 140 (see FIG. 1b, FIG. 2a, FIG. 2c). The operating system of IC chip 102 further provides for power management by recognizing the presence of card 100 while inside a laser CD or DVD drive and determining the external device laser idle time wherein chip 102 issues a command to the external device to direct the laser beam to the laser light photoelectric current generating cells in area 180 in FIG. 1b.

The overall data management of the combination card in the invention can be better understood by referring to the block diagram in FIG. 3b, which illustrates a data management aspect of one embodiment of the present invention. Blocks 200, 300 and 400 represent external devices. Blocks 140, 150, 160 and 170, which have been described in detail hereinabove, act as interface ports for the communication of chip 102 with external devices 200, 300 and 400. Blocks outlined by border 190 make up the passive card aspect of the Internet Identification Device embodiment of the present invention, which is described in greater detail hereinbelow.

The external device therefore has a capacity to communicate data to the RAM, ROM and EPROM areas integrally contained within chip 102 by means of matching contacts on external device 200 and terminal 170 of card 100. When the terminal of external device 200 contacts card terminal 170, the resultant connection enables card chip 102 to communicate all pertinent data to or from the RAM, ROM, and EPROM areas in chip 102. Typical examples of external device 200 are computing devices at credit card agencies, telephonic devices, and automatic transaction devices.

Another type of external device includes a Compact Disc drive (CDD) or Digital Video Disc (DVD) 300, preferably connected to a computing device. Compact disc drive (CDD) 300 further enables the inventive combination card 100 to communicate by means of optical data transmission. One of these means is a laser-writing compact disc drive. The coherent beam laser in such a device is capable of reading and writing to the laser-read and write ROM and RAM areas 160 of card 100. Operation system commands on card chip 102 enable further data communication between CDD or DVD 300 to exchange data with card chip 102 by directing the external device lens to read from and to beam data to the input and output area of optical data area 140, which is operatively connected to chip 102.

The energy required for data emission by optical data area 140 is supplied by storage cell 130. Likewise, when data is to be communicated to chip 102, operation system commands on chip 102 direct CDD or DVD 300 to position its writing laser over area 140, thereby communicating data into the data input (light absorbing) cells of optical data area 140, and subsequently resulting in chip 102 processing the received data in the required manner.

An external device may also include a magnetic reader writer 400. This type of device is commonly found in bank automatic transaction machines, credit card readers and security access devices. According to one aspect of the present invention, card 100 is inserted into or slid through a magnetic reader writer 400 to communicate with a device or system network connected with magnetic reader writer 400. When card 100 is used as a security pass, as one of the credit cards in a card 100 portfolio or as an automatic transaction machine card, all data communicated to card 100 through magnetic input and output area 150 is utilized by card chip 102 and further processed, and any pertinent information is communicated in the reverse manner through magnetic input and output area 150 onto external device magnetic reader writer 400.

Chip 102 contains integrated circuitry that further includes regions corresponding to the Central Processing Unit (CPU), EPROM, ROM and RAM. The EPROM and RAM regions are capable of storing operation system commands governing I/O (input and output) processes such as CD or DVD optical data exchange, data exchange through the optical emission and absorption and magnetic reader area. These regions are also capable of governing security protocols and storing security data such as encryption, identification, scheduling and verification data. These regions of chip 102 also keep track of optical data allocations on the laser recordable area. Chip 102 preferably conforms to the International Standards Organization Standard 7816-2.

IC chip 102 further includes a surface mounted electric contact of the kind conforming to ISO 7816-2 standards. When card 100 is inserted into any external device designed to accept and interface with such a contact area, the contact area provides the combination card with all electric power connection as well as data input and output connection, through which the IC chip 102 Random Access Memory (RAM), Read Only Memory (ROM) and Electrically Programmable Read Only Memory (EPROM) data are communicated with the external device.

IC chip 102 in card 100 is also operatively connected to a light-emitting device within optical data area 140, which serves as an alternate data output port for chip 102. Data input to IC chip 102 is accomplished by a light absorption area that contains sensors that serve as a data input port.

During the use of card 100 inside an external device, it may be necessary for data stored in IC chip 102 to be accessed by the external device. In this situation, the operating instructions of IC chip 102 direct an optical reading or writing lens of the external device to be positioned directly over the LED, depending on required operation, and exchange data with the card combination of the invention. This feature in the invention further expands external device interactive capacity.

Card 100 of the present invention is powered by at least one of a variety of electric current sources. On the surface of the four corners of side B of card 100 and external to optical data area 140, containing solar cells connected to storage cell 130 that directly powers IC chip 102. The combination card is also powered by a band of photoelectric cells located concentrically to and within the optical data bands. When the combination card in the invention is being utilized inside a compact disc reader, one of the commands contained within the optical data area of the combination card directs the compact disc drive laser to be positioned over the band of photoelectric current generating cells whenever the laser is in an idle mode (e.g., when the laser element has not been commanded to read or write) thereby converting the energy of the laser beam into electric energy. In an optional and presently preferred embodiment, energy storage cell 130 is a battery that supplies power to chip 102, and carries sufficient charge so as to provide power to chip 102 for at least one year of normal use.

As described above, on side A of card 100 is disposed an ambient light photoelectric current generating cell area 110, and area 120 on side B contains additional photoelectric current generating cells. In a preferred embodiment, these photoelectric areas are operatively connected to a thin storage cell disposed within card 100. The advantage of this power generating and storage aspect of the invention is that the power requirements of the combination card are substantially met in any conditions where ambient light is present, when the primary functions of the combination card are being utilized inside the compact disc drive and also in a contingency in which a light source is unavailable.

Thus, the above-described inventive combination card having an on-board IC chip provides the following features:

An expandable set of owner security pass cards;

An expandable set of owner credit cards;

An expandable set of owner accounts in banking, investment, insurance, debit, and shopping institutions as well as memberships in clubs and societies having a restricted membership;

An expandable portfolio of owner security codes, passwords, security keys and other identity and information security programs protecting the financial information and other private data of the combination card owner;

A set of programs referred to as an application for an external computing device, wherein the above features can be individually accessed, managed, organized and modified;

A feature combining a compact disc with optically readable ROM and RAM information, wherein the data stored on the inventive card provides the owner with control over information and transaction security, passwords, security keys, codes and other security operation data required for significantly improving communication and transaction security between the owner and other institutions and persons; and utilizing the above combination of the compact disc and the ROM and RAM areas to prevent any copying of music information contained on same compact disc.

An additional aspect of the present invention is an Internet Identification Device. This device has an “active card” aspect and a “passive card” aspect. In the passive card aspect, the optically readable RAM and ROM areas of the combination card include:

1. an encryption management program;

2. a personal encoding algorithm for the cardholder; and

3. a decoding algorithm for the destination party.

The algorithms and the encryption keys are selected from commercially-available types, or alternatively, are custom-written by or for a card-issuing authority.

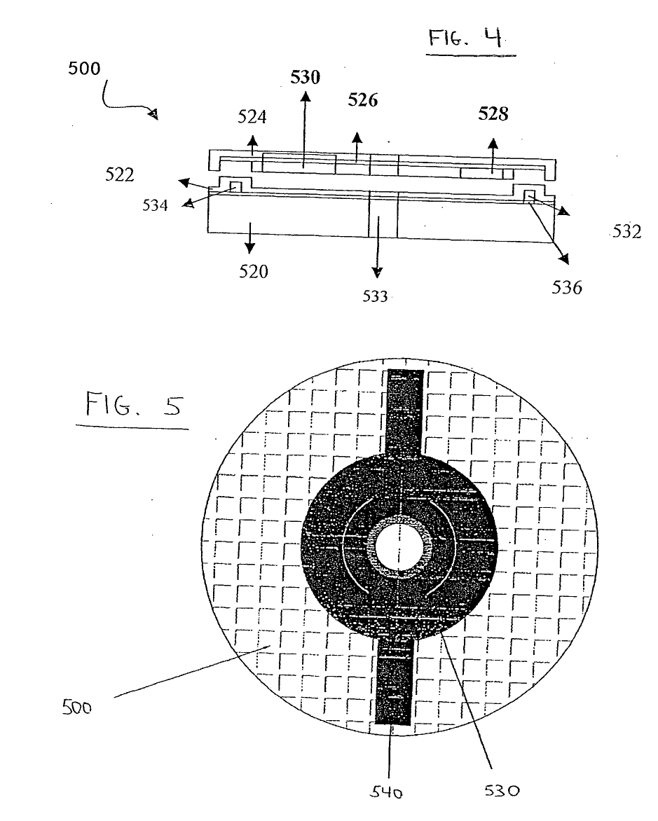

In another embodiment of the present invention, the card is a CD-like optical card that can be operated from a CD Drive. The optical card can be of various designs. One design of an optical card 500, shown schematically and by way of example in FIG. 4, includes a lower layer 520, which is a normal CD-R having a reflector layer 522, and a cover plate 524. Disposed in cover plate 524 are a printed circuit 526, a chip 528, and a battery 530. A diode (LD or LED) 532 is operatively connected to lower layer 520. Optical card 500 has a conventional central, circular opening 533.

The requisite data is burned onto lower layer 520. This data has an inventive pit format, which is needed to overcome some of the polarization effect obtained when light is transferred through the CD-media. After the data is burned on the CD-media (lower layer 520), reflector layer 522 is removed, creating a window under the optical elements such that a fully transparent medium is obtained. Subsequently, diode 532 is glued to lower layer 520, and reflector layer 522 is reinstated. It must be emphasized that the gluing procedures are conventional, and are substantially identical to bonding procedures implemented in DVD bonding stations. A similar procedure is used to attach silicon detector 534 to lower layer 520.

In another embodiment of the present invention, diode 532 and/or detector 534 are designed to act as a reflector, such that reflector layer 522 need not be reinstated.

Cover plate 524 is a circular plastic plate having the some format as the CD (a full normal CD Diameter of 120 mun, a circular opening of 15 mm in the center of the plate, etc.). The thickness of cover plate 524 is about 0.9 mm. Cover plate 524 is prepared with holes and depressions to accommodate printed circuit 526, chip 528, and battery 530. In the final stage, cover plate 524 is bonded and pressed on to reflector layer 522 to obtain optical card 500, which has a total thickness of about 0.9 mm-2.1 mm.

The design of pits 536 differs from that of standard pits in terms of the length of each pit and the distance between succeeding pits.

The special features in this system include:

a) the inclusion of electronic parts and circuit to a CD or a CD-R;

b) by the disposition of pits under the windows disposed under-diode 532 and detector 534.

Optionally and preferably, lower layer 520 is a DVD or DVD-R layer, manufactured in a CD mastering format or a DVD mastering format. In this hybridization of CD technology with a DVD platform, a substantially thinner device is obtained. The total thickness is less than 1.25 mm, and can be as low as 0. 1 mm.

In a preferred embodiment, provided in FIG. 5, battery 530 is substantially annular and concentric with the central opening of disc 500, such that the weight in disc 500 is better distributed, such that the rotational dynamic balance of disc 500 is improved. Printed Circuit Board (PCB) 540 is operatively connected to battery 530.

Transferring Information from the Drive to the Medium

There are two basic, inventive methods for transferring information from the drive to the medium:

a) “On/Off” method;

b) “Focus manipulating” method.

It should be emphasized that a third method, in which a modulated beam is used, is also feasible. This method is primarily suitable for CD Writer drives, which intrinsically have a modulated beam. However, it is also possible to manufacture a regular CD drive having an IC that allows a modulated beam over the on/off pin.

The “On/Off” Method

The “off” command is not used, thus avoiding the problem of bringing the drive to “0” position each time. In the inventive method, the on/off effect is obtained by using the commands “Activate Reading” and “Reload Track”, for example, the commands “Activate reading” and “Reload Track” of the “ATAPI” protocol.

The description of the ATAPI command for: “Activate reading” is as follows:

| | |
|---|---|
| AR = | 0x0020 |

The description of the ATAPI command for: “Reload Track” is as follows:

| | |
|---|---|
| RL = | 0x00E1 |

Using the SCSI protocol, the same approach is used, but utilizing the relevant, corresponding set of commands.

As used herein, the term “OS discovering” refers to the series of automated steps that a drive performs when closing the tray. This series of steps typically includes:

1. checking if a medium is present.

2. checking if the medium has a supported data format.

3. checking if the medium has an auto-run sequence.

4. if the medium has no auto-run sequence, switching off the drive after a pre-determined duration (e.g., 5 sec.).

The procedure of the On/Off method is as follows:

1. Upon insertion of the medium, the normal state of the LD (laser diode) is “off”.

2. After “OS discovering”, the drive is free, such that control for our purposes is enabled.

3. “Activate Reading” command for turning “On” the LD.

4. Utilize the “Reload Track” command for turning the LD into an “Off/On” state.

In an exemplary protocol of the present invention, the 3-bit sequence “101” equals “0” and “010” equals “1”.

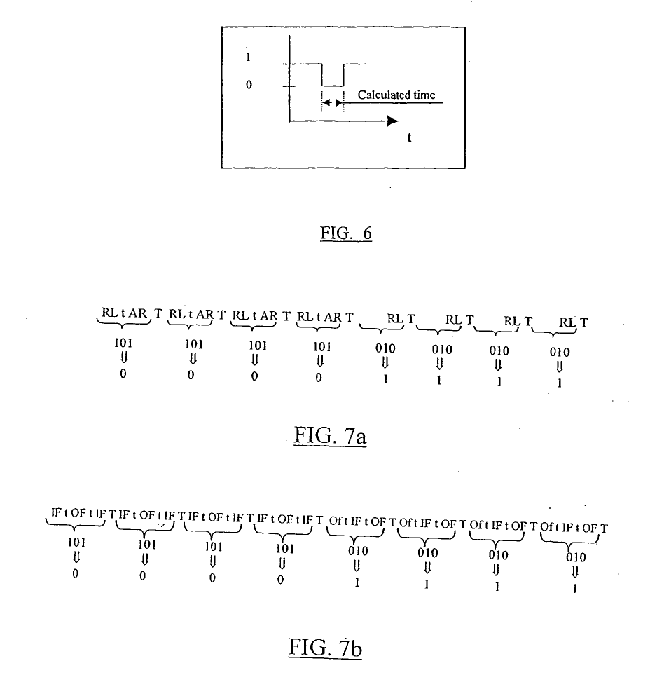

The “Reload Track” command causes the LD to flash on and off according to a given pulse, or characteristic time, as shown in FIG. 6. In typical protocol applications, the “Reload Track” command is followed by another command that repeats the flashing pattern. In the present invention, however, a single “Reload Track” command is sufficient, providing a signal of 1 followed by 0. The “activate reading” command turns the diode “on”, providing a signal of 1. Together, a signal of 101 is provided.

By way of example, the sequence of command for a binary signal of “00001111” is provided in FIG. 7a. In FIG. 7a, the following abbreviations and symbols are used:

RL ? “Reload Track”

AR ? “Activate reading”

T ? time between bits

t ? time between commands.

As used herein in the specification and in the claim section that follows, the term “on/off method” refers to various methods for obtaining signals of “1” and “0”, and/or combinations thereof, such that optical information can be transmitted, wherein at least some, and preferably all of the “0” signals are obtained without bringing the head of the drive to “0” position.

The “Focus Manipulating” Method

A second inventive method is that of “coordinate change”. In this method, the solenoid of the lens is commanded to move in and out from beneath the detecting area. When the lens of the laser head is beneath the detector, a strong signal, which is associated with “1”, is obtained. When the head moves out of the area of the detector, the signal drops below a specified level, such that “0” is obtained.

As used herein below, the “necessary focus area” refers to the area of all addresses that are in the zone of the detector.

As used herein in the specification and in the claim section that follows, the term “medium” refers to the optical smart card or combination card, including the disc and microprocessor.

The procedure of the Focus Manipulating method is as follows:

1. As soon as the medium is inserted, the normal state of LD is “off”.

2. After “OS discovering”, the drive is free and controllable.

3. Access and activate the drive (LD is now “on”).

4. Change the current coordinates of the head (using the “seek” command) such that the solenoid moves the lens under the “necessary focus area” and a value of “1” is obtained.

5. Change the current coordinates of the head (using the “seek” command) such that the solenoid moves the lens out of the border of the “necessary focus area” and a value of “0” is obtained.

The description of the ATAPI command for: “SEEK” is as follows:

| | |
|---|---|
| SEEK = | 0x0070 |

By way of example, the sequence of command for a binary signal of “00001111”, using the Focus Manipulating method, is provided in FIG. 7b. In FIG. 7b, the following abbreviations and symbols are used:

IF ? “In Focus” (“1”), and includes all necessary commands for drive.

OF ? “Out of Focus” (“0”), and includes all necessary commands for drive.

T ? “time between bits”.

t ? “time between commands”.

Radial Tracking and Signal Under the Detector

Preferably, lower layer 520 is transparent or semi-transparent. In another preferred embodiment, lower layer 520 has a transparency ratio that varies according to the wavelength used. In any event, the transparency ratio is such that sufficient light passes through so as to enable the procedure described hereinbelow.

The device and method for obtaining a signal under the photo-detector area are shown schematically in FIG. 5a. Semi-transparent layer 520 allows a part of a transmitted laser beam (Tx) to pass through (Rx₁) and reach detector 534 on the medium. The other part (Rx₂) is returned, enabling normal operation of the CD-Drive.

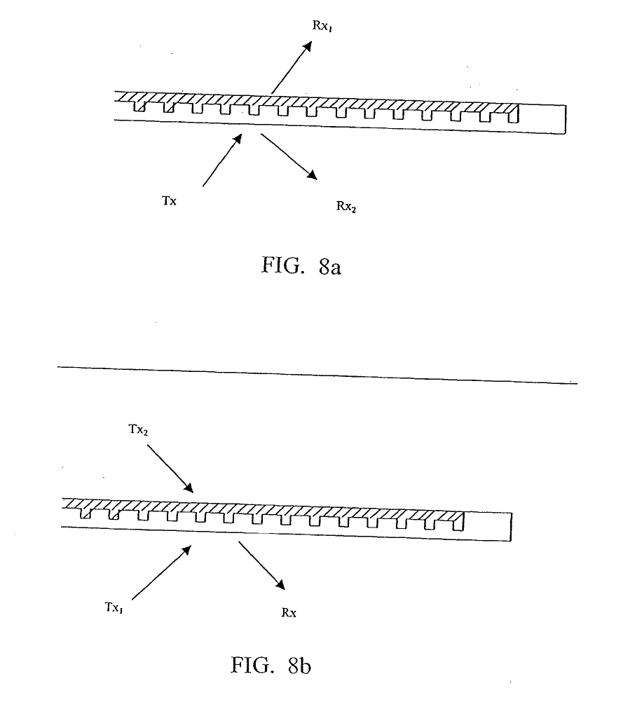

In a similar fashion, information is returned from the medium under the LED, as shown schematically in FIG. 8b. But during synchronization of the pits, the transmitter must be turned off.

The exact timing of synchronization pits can be described by an adaptive algorithm that learns the characteristic time unit of the on/off flashing and incorporates this measured time unit into the formula for the various commands such as “t”.

Experimental verification of the above was performed as follows:

An IR-LED (Infra Red Light Emitting Diode) was installed on a semi-transparent medium. This LED, which has a wavelength of 600-1100 n, served as a transmitter. A chip of the type “PIC's 16FS4” (manufactured by Microchip Ltd.) was installed on the medium. A third component installed on the medium was a detector type PN silicon photo diode, manufactured by UDT. Other components installed include a printed circuit and a battery.

To verify the transmission of information from the medium to the drive, the medium was connected to a signal generator providing a signal to the LED. The LED blinked according the signal received. The laser head on the CD-ROM drive was connected to an oscilloscope, which provided a graph representing the signal received. The signal displayed on the oscilloscope accurately reflected the signal provided by the signal generator.

The transmission of information from the medium to the drive was demonstrated as follows: with the CD-ROM drive connected to the signal generator, the Laser Diode of the driver head blinked according the signal received. A PN silicon photo diode, mounted on the medium, was connected to the oscilloscope. The silicon photo diode received the signal from the Laser Diode of the driver head, and the signal displayed on the oscilloscope accurately reflected this signal.

Applications

An integral procedure of any software that is programmed to be compatible with our technology is to check communication with the processor embedded on the software CD. When a user starts the software, the software client transmits a query to the optical card processor on the CD and demands authentication. The processor identifies the software, and only then the software is initiated. In case of success, the procedure is transparent to the user, who does not even know that this check was conducted. In the event that the user is trying to operate the software from an illegal copy, the client query not be answered (because illegal copies do not possess the optical card processor), and the software authentication procedure is terminated with a request for the user to install a legal copy of the software. The above-described procedure can be conducted at the beginning of a session, or at any time during the use of the software, based on a pre-designed cycle, a random cycle, etc. The identification may be fixed, pseudo-random, or any other type known to those skilled in the art.

It is evident from all of the above that the inventive technologies described herein are suitable for a host of applications, including intellectual property protection for games, software, literature, music, etc.

An additional exemplary application of the inventive technologies taught herein relates to Cookie technology. Cookie technology allows an application to install information into the computer of a user. For example, when a user visits a web site, the site may install a Cookie having unique information, such that the computer can be identified by the site during any successive visits. In the current art, the Cookie is PC-based, such that if the same user is accessing a Cookie-based service from two different computers, this will not be recognized.

According to the present invention, Cookie information is downloaded and/or uploaded to the optical card. This feature enables applications including flexible access to personalized online databases, playing with the same character from several PCs while maintaining all the accumulated history of the character.

### EXAMPLE

Reference is now made to the following example, which together with the above description, illustrate the invention in a non-limiting fashion.

In an exemplary process according to the present invention, a card holder desires to check his bank account balance, pay any new credit card company bills and make an unscheduled monetary transfer to one of his mutual fund investment programs using a standard desk top computer.

The card owner inserts his combination card 100 of the current invention into a private computer (PC) compact disc drive at his workplace. The card 100 laser recordable area 160 that is common to all recordable CD and DVD ROM areas contains the regular boot information and necessary start data of a regular recordable CD and DVD ROM, and this data from area 160 is subsequently read by the CD or DVD drive lens. This data positively identifies the owner card as “John Smith's Personal Genius Manager” on the computer's drive D on-screen display, and not as a musical CD-ROM, DVD or a software installation CD-ROM disc.

Further pressing of the drive D display icon displays data from CD ROM area 160, and initiates an identification process. The computer dialog box opens and prompts the card owner to enter his password. Upon pressing the Enter key, the card 100 CD or DVD ROM data uploaded into the CPU of the PC directs the PC back to card 100 to locate the necessary validation information including card owner passwords, codes, and other security tools. The card access control information can also be stored on both the card CD or DVD ROM recordable area 160 as well as chip 102 ROM and RAM and EPROM regions. However, chip 102 cannot be accessed through its electrical contacts of terminal 170 while the card is inside the computer CD or DVD drive. Alternate access to the chip 102 ROM, RAM and EPROM areas is enabled through the input/output region of optical data area 140. As a result of start-up operating instructions read from area 160, the computer CD or DVD drive reading lens beam is directed to read specific sector of tracks on card 100, which are in effect optical data area 140. Data emission and absorption cells disposed in this area are chip 102 input and output optical interface. Upon receiving querying data from the computer through any of optical data area 140, chip 102 recognizes the event as necessitating a start of the access validation procedure. The user-entered password is compared to the card access password contents stored on chip 102 EPROM area and laser recordable area 160. The same comparison procedures are repeated upon prompting the card user for further code words and dates of his last card access, or any additional validation criteria arbitrarily preset by the user, and receiving the user response data.

After a successful validation session, the full set of PC session software is selected by chip 102 and is uploaded from area 160 into the computer. The computer screen subsequently displays a menu of choices. The menu may include Check Bank Accounts, Check Investments, Access Email, Access Internet, Go Shopping On Line, and My Security Manager. Since John Smith, the card owner and user, has a desire to perform banking and investment transactions, he clicks or presses on the Check Bank Accounts. This choice amplifies the Check Bank Accounts line into a list of the user banking institutions. Specifying the particular institution causes the host computer to launch its internet access application, to access the indicated institution web site or a direct on-line access channel, to supply the institution security identification querying system with correct access validation data for the user account and display all necessary acknowledgment boxes and, upon a successful establishment of communication, to display typical choices for user financial information.

While the user is performing operations on-line and no data is being accessed from his card 100, chip 102 further recognizes the idle time and issues through any chip data optical output cells of optical data area 140 to flash a command to the computer CD or DVD drive lens to position itself over area 180, with no instructions for further reading until the next request for data from card 100. The positioning of the laser beam over area 180 causes laser illumination of area 180 photoelectric current generating cells, subsequently generating electrical power for the storage cell 130.

After the card user has verified that the written checks have cleared, that the electronic fund transfer of his monthly salary payment has been carried out, and that the account balance agrees with the account balance stored on the card, the user clicks on the Personal Investing pull down menu bar and selects a specific mutual funds investment institution by name from a list of his investment portfolio. In the background of the computer session, the pertinent instruction from chip 102 launches any necessary applications. Web access and security procedures with data therefor is supplied from areas 140, 160 and chip 102 RAM, ROM and EPROM regions. The user subsequently specifies the series of Make Investment and Gold Trust Medium Risk options and is further prompted to specify the dollar amount or the number of shares, and to approve the transaction. Upon successful conclusion of one or more financial transactions, the user chooses from any displayed menus to terminate sessions and conclude the current operation. The software acknowledges closing of all applications and prompts the user to extract his card 100 from the computer CD or DVD drive.

Although the invention has been described in conjunction with specific embodiments thereof, it is evident that many alternatives, modifications and variations will be apparent to those skilled in the art. It must be emphasized that the inventive technologies described herein are suitable for a host of applications, including intellectual property protection for games, software, literature, music, etc. Accordingly, the invention is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An optical communication device comprising:
(a) a data card having:
(i) a computing unit, and
(ii) an optical communication element operatively connected to said computing unit,
said optical communication element for transferring optical information between said data card and an external device.

2. The device of claim 1, wherein physical dimensions of said card resemble a credit card.

3. The device of claim 1, wherein a first side of said card includes an optical data area.

4. The device of claim 1, wherein a second side obverse to said first side includes an electrical contact area.

5. The device of claim 1, wherein at least one of said sides of said card includes at least one electric current generation area.

6. The device of claim 4, wherein said sides include a magnetic contact area.

7. The device of claim 1, said card further including:
(iii) an energy storage cell for providing energy to said computing unit.

8. The device of claim 7, wherein said storage cell includes an electric battery.

9. The device of claim 5, wherein said electric current generation area includes at least one type of cell selected from the group consisting of photoelectric cell, photovoltaic cell, and solar cell.

10. The device of claim 9, wherein said computing unit is operatively connected to said cell.

11. The device of claim 8, wherein said battery is disposed so as to provide substantially even radial weight distribution of said card.

12. The device of claim 8, wherein said card is substantially circular.

13. The device of claim 1, said data card further including:
(iii) a sector-shaped optical data area, said sector-shaped area extending less than 360°.

14. The device of claim 1, wherein said card is a compact disc.

15. The device of claim 1, wherein said external device is a compact disc (CD) drive.

16. The device of claim 1, wherein said external device is a compact disc (CD) drive reader.

17. The device of claim 1, wherein said card is a compact disc, said card further including:
(iii) an optically recordable data region for recording data from a laser.

18. The device of claim 1, wherein said optical communication element includes at least one light absorption device and at least one light emission device.

19. The device of claim 18, wherein said light absorption device includes photosensitive cells.

20. The device of claim 18, wherein said light emitting device includes at least one device selected from the group consisting of light emitting diode (LED), multichip micropod, LED light strip, laser diode (LD), and flexible path LED.

21. The device of claim 1, wherein said computing unit includes at least one integrated circuit chip selected from the group consisting of ceramic, reflector, flat, lens, dual color, dual color reflector, resistor and blinking chip.

22. The device of claim 1, wherein said computing unit includes a random access memory region.

23. The device of claim 22, wherein said computing unit further includes a memory region selected from the group consisting of a read only memory region, and an electrically programmable memory region.

24. The device of claim 23, wherein said memory regions contain data and programs.

25. The device of claim 24, wherein said programs include a memory access program.

26. The device of claim 24, wherein said programs include an operation system.

27. The device of claim 25 or claim 26, wherein said programs include an identification program.

28. The device of claim 25 or claim 26, wherein said programs include a data processing program.

29. The device of claim 16, wherein said CD drive reader is designed and configured to transmit optical data using an on/off method.

30. The device of claim 16, wherein said CD drive reader is designed and configured to transmit optical data using a focus manipulating method.

31. The device of claim 15, wherein said CD drive is designed and configured to transmit optical data using a modulated beam over an on/off pin.

32. The device of claim 1, wherein said optical communication element includes a light emitting diode (LED).

33. The device of claim 1, wherein said optical communication element includes a laser diode (LD).

34. The device of claim 1, said card further including:
(iii) a photo-detection element operatively connected to said computing unit.

35. A device comprised of a data disc having at least one element for generating current from a laser of compact disc (CD) drive.

36. The device of claim 35, wherein said disc includes a computing unit operatively connected to said element.

37. The device of claim 35, wherein said element includes at least one cell selected from the group consisting of photoelectric and photovoltaic cells.

38. The device of claim 35, further comprising solar cells for additional generation of electrical current.

39. The device of claim 35, further comprising a battery for storing said current and for providing additional current as needed.

40. A method for communicating information comprising the steps of:
(a) providing a device including a data disc having:
(i) a computing unit, and
(ii) an optical communication element, operatively connected to said computing unit;
(b) communicating optical information between said data disc and an external device using said optical communication element.

41. The method of claim 40, wherein said communicating optical information includes receiving an optical input from an external light source using said optical communication element.

42. The method of claim 40, wherein said communicating optical information includes transmitting an optical output to an external device using said optical communication element.

43. The method of claim 40, wherein said optical communication element is a diode selected from the group consisting of a light emitting diode (LED) and a laser diode (LD).

44. The method of claim 40, wherein said computing unit processes digital information.

45. The method of claim 44, wherein said digital information includes programs for operation of said device.

46. The method of claim 40, wherein said computing unit processes at least one type of data selected from the group consisting of permanent, temporary and write-once data.

47. The method of claim 40, wherein said computing unit processes data containing information selected from the group consisting of financial, security, identification and personal information.

48. The method of claim 40, wherein said external light source is operatively connected to a CD-drive.

49. The method of claim 41, wherein said receiving an optical input is performed using an on/off method.

50. The method of claim 41, wherein said receiving an optical input is performed using a focus manipulating method.

51. The method of claim 41, wherein said receiving an optical input is performed using a modulated beam.

52. The method of claim 41, wherein said receiving an optical input is performed using an OS discovering process.

53. The method of claim 41, wherein said receiving an optical input is performed using a Reload Track command.

54. The method of claim 41, wherein said receiving an optical input is performed using a SEEK command.

55. The method of claim 41, wherein said receiving an optical input is performed by controlling a position of a lens of said external light source such that said lens moves in and out from beneath a detecting area.

56. The method of claim 40, wherein said computing unit communicates with an optical data storage area disposed on said disc.

57. The method of claim 40, wherein said optical data storage area includes recordable, readable, permanent, read-only, and write-once only areas.

58. The method of claim 40, wherein said computing unit processes operation system commands.

59. The method of claim 40, wherein said computing unit controls communication of said disc with an external device by means of said optical communication element.

60. The method of claim 40, wherein data disposed in said computing unit is received from and communicated to an optical storage area by means of said light source.

61. The method of claim 40, further comprising the step of:
(c) encrypting data on said disc.

62. The method of claim 40, further comprising the step of:
(c) encrypting data,
wherein said data is encrypted by at least one algorithm disposed on said disc.

63. The method of claim 40, further comprising the step of:
(c) encrypting data,
wherein said encrypting data is performed using a canned encryption routine.
